(19) United States
(12) Patent Application Publication
(10) Pub. No.: US 2008/0107872 A1
(43) Pub. Date: May 8, 2008

(54) Artificial cane

(76) Inventor: Chien-Yeh Chen, Sanchong City (TW)

Correspondence Address: Cooper & Dunham LLP, 1185 Avenue of the Americas, New York, NY, 10036, US

(21) Appl. No.: 11/592,391

(22) Filed: Nov. 3, 2006

(51) Int. Cl. B32B 1/00

(52) U.S. Cl. 428/179

(57) ABSTRACT

An artificial cane has a central strip, multiple spokes and multiple intervals. The central strip is bendable and has an outer surface. Each spoke is a strip, is formed and protrudes spirally from the outer surface of the central strip and has a proximal section, a distal section and an inner surface. The proximal section is formed and protrudes spirally from the outer surface of the central strip. The distal section of one spoke extends toward the proximal section of an adjacent spoke and all distal sections extend toward a same rotational direction. Each interval is formed between the outer surface of the central strip and the inner surface of one spoke. An appearance and a tenacity of the artificial cane are similar to those of the natural cane. Moreover, a cane work made by the artificial canes will be stable, secure and inexpensive.

### BACKGROUND OF THE INVENTION

1. Field of Invention

The present invention relates to an artificial cane, and more particularly to an artificial cane that is made by polymer to prevent real canes from being over-felled.

2. Description of the Related Art

A natural cane has an excellent resilience, so it is easy to cane a cane work such as furniture, a hat, cushion or the like. The cane work is light and cool, so the cane work is popular. However, the natural cane is over-felled and is decreased. Thus, to fell the natural canes is banned these years due to environmental consciousness. Consequently, the cane work is more expensive.

To overcome the shortcomings, the present invention provides a natural cane to mitigate or obviate the aforementioned.

### SUMMARY OF THE INVENTION

The primary objective of the present invention is to provide an artificial cane that is made by polymer to prevent real canes from being over-felled.

To achieve the objective, the artificial cane in accordance with the present invention has a natural cane-like appearance, tenacity, a central strip, multiple spokes and multiple intervals. The central strip is bendable and has an outer surface. Each spoke is a strip, is formed and protrudes spirally from the outer surface of the central strip and has a proximal section, a distal section and an inner surface. The proximal section is formed and protrudes spirally from the outer surface of the central strip. The distal section of one spoke extends toward the proximal section of one of an adjacent spoke and all distal sections extend toward a same rotational direction. Each interval is formed between the outer surface of the central strip and the inner surface of one spoke. The appearance and the tenacity of the artificial cane are similar to those of the natural cane. Moreover, a cane work made by the artificial canes will be stable, secure and inexpensive.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an artificial cane in accordance with the present invention;

FIG. 2 is a cross sectional view of the artificial cane in FIG. 1 with a circular cross section;

FIG. 3 is a cross sectional view of an artificial cane in accordance with the present invention with a through hole;

FIG. 4 is a cross sectional view of an artificial cane in FIG. 3 with a filler filled in the through hole;

FIG. 5 is a cross sectional view of the artificial cane in accordance with the present invention with a quadrilateral cross section; and

FIG. 6 is a cross sectional view of an artificial cane in accordance with the present invention with non-regular spokes.

### DETAILED DESCRIPTION OF THE INVENTION

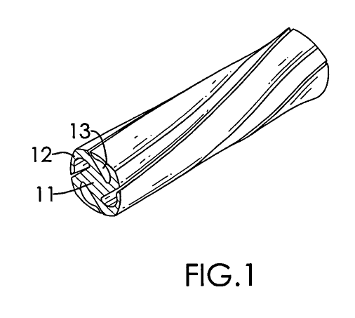

With reference to FIG. 1, an artificial cane in accordance with the present invention has a natural cane-like appearance, tenacity, a cross-section, a central strip (11), multiple spokes (12) and multiple intervals (13).

With further reference to FIG. 5, the cross-section of the artificial cane may be circular, or polygonal such as triangular, quadrilateral. The circular cross-section has a diameter between 1.5 mm to 8.0 mm.

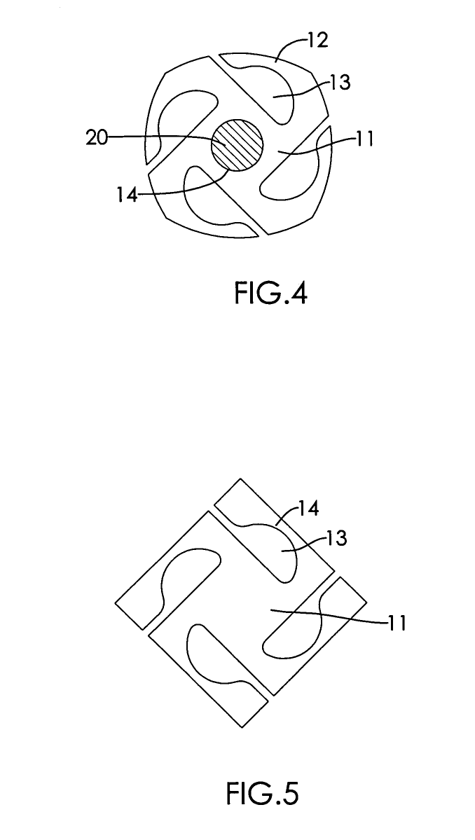

With further reference to FIGS. 3 and 4, the central strip (11) is made by polymer such as polyethylene (PE), polyvinyl chloride (PVC), polypropylene (PP) or the like. The polymer, such as polyethylene (PE), polyvinyl chloride (PVC), polypropylene (PP) or the like, may be treated by a plastic foaming procedure. The central strip (11) is bendable and has an outer surface and a cross-section and may have a through hole (14). The cross-section of the central strip (11) may be quadrilateral. The through hole (14) is defined through the central strip (11) to make the central strip (11) light and easy to be bent, so the artificial cane is caned easily. The through hole (14) may be filled by a filler (20). The filler (20) is filled in the through hole (14) and may be polyester such as polyethylene terephthalate (PET) or the like to strengthen the tenacity of the artificial cane.

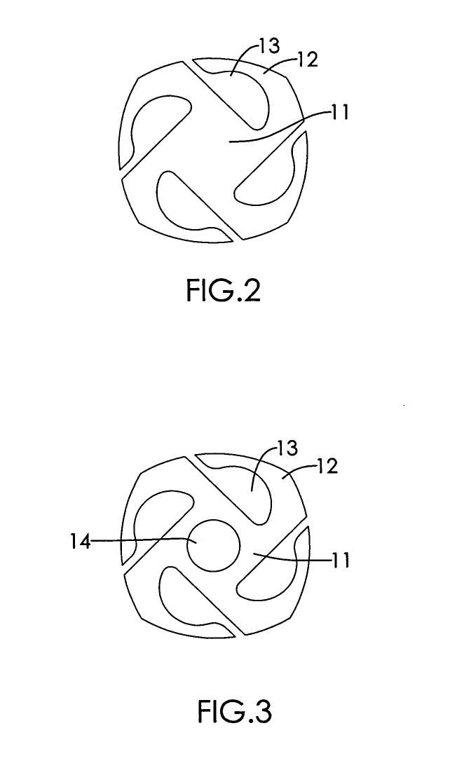

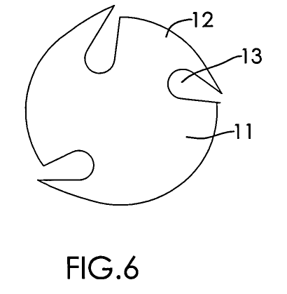

With further reference to FIGS. 2 and 6, the spokes (12) are made by polymer such as polyethylene (PE), polyvinyl chloride (PVC), polypropylene (PP) or the like. The polymer, such as polyethylene (PE), polyvinyl chloride (PVC), polypropylene (PP) or the like, may be treated by a plastic foaming procedure. Each spoke (12) is a strip, is formed and protrudes spirally from the outer surface of the central strip (11) and has a length, a proximal section, a distal section and an inner surface. The lengths of the spokes (12) may be equal and symmetrical or may be unequal. The proximal section of the spoke (12) is formed and protrudes spirally from the outer surface of the central strip (11). The distal section of the spoke (12) extends toward the proximal section of an adjacent spoke (12) and all distal sections extend toward a same rotational direction. The interval (13) correspond respectively to the spokes (12) and each interval (13) is formed between the outer surface of the central strip (11) and the inner surface of a corresponding spoke (12), so the artificial cane is more like a natural cane and will not generate cracks or break when the artificial cane is bent. The intervals (13) may have an equal and symmetrical space or may have an unequal space.

The appearance and the tenacity of the artificial cane are similar to those of the natural cane. Moreover, when the artificial canes are caned, the spoke (12) that is pressed by an adjacent spoke (12) will slightly sink into the interval (13). The spoke (12) and the adjacent spoke (12) will be combined securely and a cane work made by the artificial canes will become more stable, secure. Thus, the artificial cane can substitute the natural cane to decrease a

price of the cane work. Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An artificial cane having
a central strip being bendable and having an outer surface;
multiple spokes and each spoke being a strip, formed and protruding spirally from the outer surface of the central strip and having
a proximal section formed and protruding spirally from the outer surface of the central strip;
a distal section extending toward the proximal section of an adjacent spoke and all distal sections of the spokes extending toward a same rotational direction; and
an inner surface;
multiple intervals corresponding respectively to the spokes and each interval formed between the outer surface of the central strip and the inner surface of a corresponding spoke.

2. The artificial cane as claimed in claim 1 further has a circular cross-section.

3. The artificial cane as claimed in claim 1 further has a quadrilateral cross-section.

4. The artificial cane as claimed in claim 1 further has a polygonal cross-section.

5. The artificial cane as claimed in claim 1 further has a circular cross-section having a diameter between 1.5 mm to 8.0 mm.

6. The artificial cane as claimed in claim 1, wherein the central strip has a quadrilateral cross-section.

7. The artificial cane as claimed in claim 1, wherein the central strip and the spokes are made by polyethylene (PE).

8. The artificial cane as claimed in claim 1, wherein the central strip and the spokes are made by polyvinyl chloride (PVC).

9. The artificial cane as claimed in claim 1, wherein the central strip and the spokes are made by polypropylene (PP).

10. The artificial cane as claimed in claim 1, wherein the central strip and the spokes are made by polyethylene (PE) treated by a plastic foaming procedure.

11. The artificial cane as claimed in claim 1, wherein the central strip and the spokes are made by polyvinyl chloride (PVC) treated by a plastic foaming procedure.

12. The artificial cane as claimed in claim 1, wherein the central strip and the spokes are made by polypropylene (PP) treated by a plastic foaming procedure.

13. The artificial cane as claimed in claim 1, wherein the central strip has a through hole defined through the central strip

14. The artificial cane as claimed in claim 13, wherein the through hole of the central strip is filled by a filler.

15. The artificial cane as claimed in claim 14, wherein the filler in the through hole is polyester.

16. The artificial cane as claimed in claim 14, wherein the filler in the through hole is polyethylene terephthalate (PET).
